(19) United States
(12) Patent Application Publication
(10) Pub. No.: US 2024/0249079 A1
(43) Pub. Date: Jul. 25, 2024

(54) SYSTEM AND METHOD FOR AN INTEREST ENGINE

(71) Applicant: Cvent, Inc., Tysons Corner, VA (US)

(72) Inventors: Lashkar KASHIF, Tysons Corner, VA (US); Yuanyuan GUO, Tysons Corner, VA (US)

(73) Assignee: Cvent, Inc., Tysons Corner, VA (US)

(21) Appl. No.: 18/559,924

(22) PCT Filed: May 20, 2022
(86) PCT No.: PCT/US2022/030228

§ 371 Date: Nov. 9, 2023

Related U.S. Application Data
(60) Provisional application No. 63/190,882, filed on May 20, 2021.

(51) Int. Cl. G06F 40/295; G06F 40/242; G06Q 50/00

(52) U.S. Cl. CPC G06F 40/295; G06F 40/242; G06Q 50/01

(57) ABSTRACT

Systems, methods, and computer-readable storage media for using real-time Natural Language Processing (NLP) to extract key phrases from text associated with actions being taken by an attendee of a live event. Using that key phrase data, the system can build a weighted collection of key phrases associated with contacts, attendees, sessions, and/or other areas of interest, and provide suggestions to the user/attendee regarding who to meet, what sessions to attend, what exhibitors to visit, etc.

### CROSS-REFERENCE TO RELATED APPLICATION

This application claims priority benefit of the filing date of U.S. Provisional Patent Application No. 63/190,882, filed on May 20, 2021, which is herein incorporated by reference in its entirety.

### BACKGROUND

### 1. Technical Field

The present disclosure relates to identifying interests of users at an event, and more specifically to using Natural Language Processing (NLP) to extract key phrases from user actions, execute matchmaking algorithms on those key phrases, and provide suggestions to the user.

### 2 Introduction

When attending events, whether in-person (such as conferences or parties), virtual meetings, or hybrid events, identifying which other attendees have similar interests, or interest trends, as a given attendee can be difficult. While some events will have attendees fill out a questionnaire of interests before attending, and attempt to introduce people based on those pre-attendance questionnaires, those questionnaires fail to capture real-time changes in an attendees interest. If, for example, an attendee has already submitted their pre-attendance questionnaire and begins speaking with an individual, the attendee may become interested in new topic “X.” A pre-attendance questionnaire and related suggestions will not assist the attendee in finding resources related to topic X.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described herein. A method for performing the concepts disclosed herein can include: training an attendee matchmaking algorithm, by: inputting, into a computer system, attendance data from multiple past events; inputting, into the computer system, registration data from the multiple past events; inputting, into the computer system, session data from the multiple past events; executing, via a processor of the computer system, a sensitivity analysis on the attendance data, the registration data, and the session data, resulting in relevance coefficients; and generating, via the processor, the attendee matchmaker algorithm using the relevance coefficients; receiving, at the processor, recorded audio from a mobile computing device of an attendee of an ongoing event; executing, via the processor, natural language processing on the recorded audio, resulting in processed audio; executing, via the processor, the attendee matchmaking algorithm with the processed audio as an input, resulting in an output of the attendee matchmaking algorithm comprising ranked suggestions; and transmitting the ranked suggestions from the computer system to the mobile computing device.

A system configured to perform the concepts disclosed herein can include: a processor; and a non-transitory computer-readable storage medium having instructions stored which, when executed by the processor, cause the processor to perform operations comprising: training an attendee matchmaking algorithm, by: inputting attendance data from multiple past events; inputting registration data from the multiple past events; inputting session data from the multiple past events; executing a sensitivity analysis on the attendance data, the registration data, and the session data, resulting in relevance coefficients; and generating the attendee matchmaker algorithm using the relevance coefficients; receiving recorded audio from a mobile computing device of an attendee of an ongoing event; executing natural language processing on the recorded audio, resulting in processed audio; executing the attendee matchmaking algorithm with the processed audio as an input, resulting in an output of the attendee matchmaking algorithm comprising ranked suggestions; and transmitting the ranked suggestions from the computer system to the mobile computing device.

A non-transitory computer-readable storage medium configured as disclosed herein can have instructions stored which, when executed by a computing device, cause the computing device to perform operations which include: training an attendee matchmaking algorithm, by: inputting attendance data from multiple past events; inputting registration data from the multiple past events; inputting session data from the multiple past events; executing a sensitivity analysis on the attendance data, the registration data, and the session data, resulting in relevance coefficients; and generating the attendee matchmaker algorithm using the relevance coefficients; receiving recorded audio from a mobile computing device of an attendee of an ongoing event; executing natural language processing on the recorded audio, resulting in processed audio; executing the attendee matchmaking algorithm with the processed audio as an input, resulting in an output of the attendee matchmaking algorithm comprising ranked suggestions; and transmitting the ranked suggestions from the computer system to the mobile computing device.

### BRIEF DESCRIPTION OF THE DRAWINGS

FIG. 1 illustrates exemplary training and use of an interest engine to generate ranked suggestions;

FIG. 2 illustrates exemplary use of an iteratively updating matchmaking service;

FIG. 3 illustrates an example method embodiment; and

FIG. 4 illustrates an example computing system.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

One exemplary, non-limiting, practical application to the technical problem noted above is to use real-time Natural Language Processing (NLP) to extract key phrases from text associated with actions being taken by an attendee of a live event, a virtual event, and/or a hybrid event (with both virtual and live attendees). Using that key phrase data, the system can build a weighted collection of key phrases associated with contacts, attendees, sessions, and/or other areas of interest, and provide suggestions to the user/attendee regarding who to meet, what sessions to attend, what exhibitors to visit, etc.

Systems configured as disclosed herein can identify interests and interest trends of attendees at a live/virtual/hybrid event. If, for example, the event were a conference being attended by an attendee with interest in machine learning, the system can identify: How many attendees have a high interest in machine learning; What other interests the conference attendees have; The other interests of conference attendees that are also interested in machine learning; The highest rated sessions about machine learning. The system can then provide, to individual attendees, customized suggestions for their interests. For example, the system can suggest with whom the attendee should network based on their intersection of interests, what exhibitors the attendee should visit based on their interests, and what sessions to attend based on their interests. Generally, the systems can provide multiple recommendations. For any event construct (e.g., a session, an exhibit, an attendee, etc.), the system builds a weighted key phrase dictionary in the same way as for an attendee. The system then intersects the event construct dictionary with that of the target attendee. For any key phrase that is common between the two dictionaries, the system computes the product of the weights, then all such products are added to yield a single score between the target attendee and the construct. The recommendations can then be ranked by this score.

Interests for a given user or attendee can be derived through one or more configurations. In some configurations, the attendee can manually enter (into a software “app” or other computer program) a list of interests. In some configurations, a system can parse videos uploaded by planners or exhibitors, use NLP on the audio from the video, and identify key phrases from the transcripts. In other configurations, a system configured as disclosed herein can use recorded audio (such as from a cell phone, tablet computer, smart watch, or other computing device), convert the audio to text via speech-to-text algorithms/processing, and extract the key phrases using the natural language processing algorithms. For example, as the user walks around the conference, the user's smartphone can use a microphone to capture audio of conversations near to the attendee (or conversations in which the attendee is participating). The user's smartphone can then transmit the audio electronically to a server or other computer system where speech to text on the audio, and NLP on the resulting text, can occur, followed by suggestions based on the key phrases detected in the text. In some configurations, the attendee's smartphone can perform the speech to text conversion, NLP processing, and generation of suggestions.

In yet other configurations, the interests of the attendee can be derived based on the locations which the user frequents. For example, if the attendee's location (as registered by a GPS location device within the attendee's smartphone) indicates that the attendee is frequenting an exhibitor booth or session associated with a particular topic (or spends a predetermined amount of time in such a location), the system can identify that topic as one of interest to the attendee.

The identification of a key phrase within the text by the natural language processing can, for example, occur by having a database of known key phrases associated with previously identified interests. As the text is received, the processor can execute a string comparison of the text and the words within the text and, when a match is found, identify a key phrase as detected. For example, the system can use a graph-based approach, such as TextRank, to identify key phrases. All text associated with activities of the attendee in an event can be input to TextRank (for example, session titles and descriptions, exhibitor descriptions). The algorithm identifies key phrases based on the frequency of occurrence, and the connectivity with other phrases, of each phrase.

Within the system, the sessions, exhibits, appointments, or other domain objects within the event space can be considered “entities” or event constructs. The system can associate these entities with specific identifications (IDs), entity types (in a string format), location (e.g., fixed coordinates or mobile), etc.

The system can also identify specific types of interactions, also termed “actions,” between an attendee and an entity, such as an attendee going to a session, performing a search on a mobile app, being scanned as a potential contact at an exhibitor, speaking with another individual, being in close contact with another individual, etc. The system can provide these actions to the attendee as suggestions. For example, the system can suggest that the attendee go speak with individual “A,” or go attend session “B.” In some configurations, the system can provide a reason for the suggestion, such as “We recommend you speak with person A because they are also interested in topic X,” or “We recommend you attend session B because they will be discussing topic Y.” In some configurations, the session recommendation can use a demographic clustering based algorithm: an attendee gets recommended sessions based on what sessions other attendees similar to them have enrolled for. The similarity for such a configuration is defined using explicit features, derived from job titles and company names of attendees. Likewise, the system can use other algorithms that use implicit measures of similarity.

In determining the interests of an attendee from text or actions, the system can identify all of the key phrases associated with the actions performed by the attendee (based on the attendee's history) and normalize each instance the key phrase or action is detected to 1. The system can then identify, based on the number of occurrences of a given key phrase or action, what weight to assign to a given interest associated with those key phrases or actions, such that those interests detected most often are weighted more heavily than others.

The system can then use the weighting assigned to given interests to identify potential matches between to entities at an event. For example, the system can take the weighted interests of each user, transform the weighted interest into a vector for that user, and perform a dot product between the vectors of respective users. The results of those dot products can then be normalized and/or ranked, such that the highest resulting dot products result in a suggested activity to the attendee(s).

To execute the interest engine, the system can execute an asynchronous batch of steps such as collecting data, converting speech to text, executing the NLP, and/or calculating the attendee's interests, followed by performing matchmaking between attendees and/or events. The system can then use a read-only API (Application Programming Interface) which serves up the matches that were computed asynchronously.

The system can, for example, run the API with dropwizard for serving matches and coordinating the async job management. The asynchronous job is a piece of python code to execute the NLP and matchmaking algorithm. The system can use AMAZON S3 (or other scalable cloud storage systems) as a data store for passing information between the matchmaking service and the matchmaking NLP job, as well as our primary data store for attendee matches and interests. S3 as a data store can provide a number of benefits. It is low maintenance, pay-for-usage, has versioning built in, and has reasonable response times for serving data. S3 may be slower than using a real key-value store like couchbase for serving API requests, but can provide a lower cost of ownership and faster delivery.

Building the interest engine can, for example, take the following steps:
1) For a given account_person_id, find all value-generating behaviors and interactions in all events (of that customer) that exist in event data stores. These can include the event registration itself, session registrations and attendance, exhibitor visits, appointments with other attendees, session speakers and exhibitors, explicitly stated interests, questions submitted, surveys taken, searches within event, presentation slides downloaded, content downloaded, content shared, emails opened, emails clicked in, and so on.
2) Extract data and metadata associated with these behaviors and interactions, for example: event name, session title description, session speaker name, exhibition title and company, text of attendee questions, any free text written in survey responses, search keywords, title of webinars or downloaded/shared content, email subject lines, etc.
3) Parse this body of text data to isolate keywords and named entities.
4) Build a dictionary in which each keyword or entity is a key (interest area), and the corresponding count of that keyword or entity found in the text data is the value.
5) Normalize the values in the dictionary such that they add up to unity. Then the value corresponding to each key is the relative strength of that interest area to that attendee. The granularity of the resulting dictionary can be reduced using, for example, clustering via probabilistic topic modeling, or using an embedded vector space.

To use the interest engine to generate suggestions for items, behaviors, and/or interactions which align with the interests of an attendee, the system can, for example:
1) For each account_person_id attending a given event, pull all relevant data from Attendee Activities. The pull may happen only once after the event, daily, or more frequently during the event.
2) Execute steps 2-5 of ‘Building an interest engine’ above on this data. If an interest engine already exists for an account_person_id, new key terms can be added, existing terms can be incremented, and the entire dictionary can be renormalized. If there is no existing dictionary for the account_person_id, it will be created.
3) The set of dictionaries can persist.

To create interest dictionaries, the system can obtain data (from an attendee activities database) via a live feed. The interest dictionaries can be created/updated along three distinct levels:
1) Attendee level: For a given account_person_id, the system can: (A) find all activities from events attended in a specific time interval, and (B) create/update the dictionary
2) Event level: For a given event_id, the system can: (A) find all activities from all account_person_ids in event, and (B) create/update dictionaries associated with the event ID and/or the attendees.
3) Time interval level: For a given time interval, the system can: (A) find all activities for all account_person_ids in all events in a time interval, and (B) create/update dictionaries for event IDs within that time interval associated with associated account IDs and/or the dictionaries for the respective attendees.

To recommend event items to attendee “A”, the system can:
1) Create an event item dictionary using TextRank on the event item text
2) Match the event item interests within the event item dictionary with interests of A, weighting each match by the weight of the interest term in A's dictionary (scaled by a function of the number of items used to build the dictionary) and the weight of the event item dictionary.
3) Extract a total relevance score “R” for A for each event item, and rank all items in each item type (sessions, exhibitors, etc.) by total relevance R.
4) For each item type, output top R recommendations to post-processing step.

The overall process can, in some ways, be considered to be a two step process: the interest engine and its uses. The interest engine is the mechanism that results in interest dictionaries for attendees and for event constructs. The dictionaries can then be used to recommend any and all event constructs.

With that basis, the disclosure now turns to the figures.

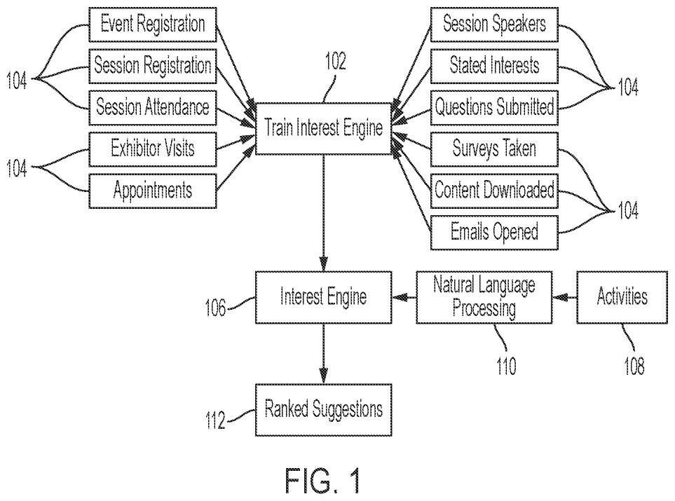

FIG. 1 illustrates exemplary training and use of an interest engine to generate ranked suggestions. In this example, the training of the interest engine 102 uses multiple data inputs 104, such as event and session registration, attendance, downloaded content, etc. The system takes this data and can identify relationships between the respective data points. For example, the system can identify how likely someone is to actually engage in a particular activity given a previously identified interests and activities, where the record of those previous interests and activities are stored in a database.

With the interest engine trained 102, the trained interest engine 104 can be used to generate ranked suggestions 112 for people to interact with, sessions to attend, materials to download, or other activities. To generate those suggestions 112, the activities 108 of the attendee are analyzed using natural language processing 110, with identified key phrases input into the interest engine 106. In some configurations, additional inputs, such as location data, can also be input into the interest engine 106.

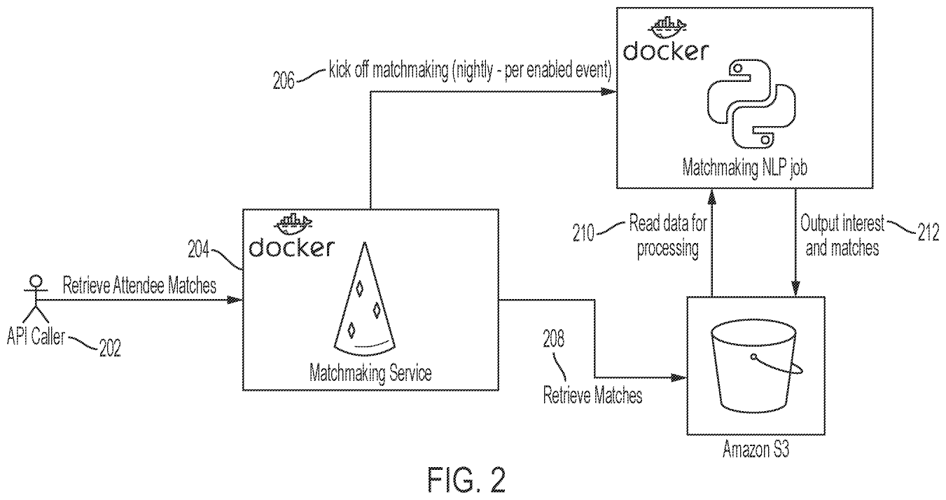

FIG. 2 illustrates exemplary use of an iteratively updating matchmaking service. As illustrated, an API caller 202 operating on a server can retrieve attendee matches 204, using a match making service 204 as disclosed herein. This can cause a periodic matchmaking 206 (such as every night), and also cause retrieval of matches by a cloud based server 208. The cloud based server 208 can provide data for the periodic processing 206, while also receiving interests and matches 212.

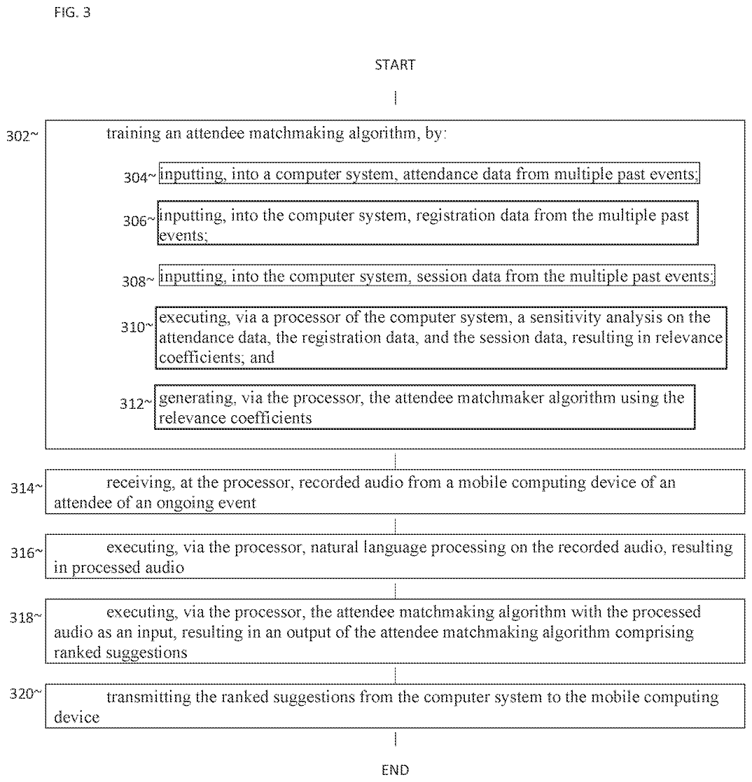

FIG. 3 illustrates an example method embodiment. As illustrated, the method can include: training an attendee matchmaking algorithm (302), by: inputting, into a computer system, attendance data from multiple past events (304); inputting, into the computer system, registration data from the multiple past events (306); inputting, into the computer system, session data from the multiple past events (308); executing, via a processor of the computer system, a sensitivity analysis on the attendance data, the registration data, and the session data, resulting in relevance coefficients (310); and generating, via the processor, the attendee matchmaker algorithm using the relevance coefficients (312). The method can then include receiving, at the processor, recorded audio from a mobile computing device of an attendee of an ongoing event (314) and executing, via the processor, natural language processing on the recorded audio, resulting in processed audio (316). The method can then execute, via the processor, the attendee matchmaking algorithm with the processed audio as an input, resulting in an output of the attendee matchmaking algorithm comprising ranked suggestions (318) and transmit the ranked suggestions from the computer system to the mobile computing device (320).

In some configurations, the sensitivity analysis for the attendee matchmaking analysis further receives, as inputs: topics of interest by the attendee; and people with whom the attendee spoke at the multiple past events.

In some configurations, the computer system is a serverless computing system.

In some configurations, the ranked suggestions can include one or more of: an individual with whom the attendee is recommended to communicate, a session of the event the attendee is recommended to attend, an exhibitor booth the attendee is recommended to visit, a web page the attendee is recommended to visit, and a meeting of multiple individuals which the attendee is recommended to join.

In some configurations, the sensitivity analysis comprises at least one of: a derivative-based local method, a regression analysis, a variance-based method, and scatter plots.

In some configurations, the illustrated method can further include: receiving location coordinates for future activities at the ongoing event; and receiving global positioning system (GPS) locations for the attendee, wherein the ranked suggestions are filtered based on a distance between the location coordinates for future activities and the GPS locations for the attendee.

In some configurations, the illustrated method can further include: receiving additional actions of the attendee after receiving the ranked suggestions; and modifying the attendee matchmaking algorithm based on the additional actions.

In some configurations, each suggestion in the ranked suggestions can include: at least one of a person to meet and a session to attend; and a reason for the suggestion.

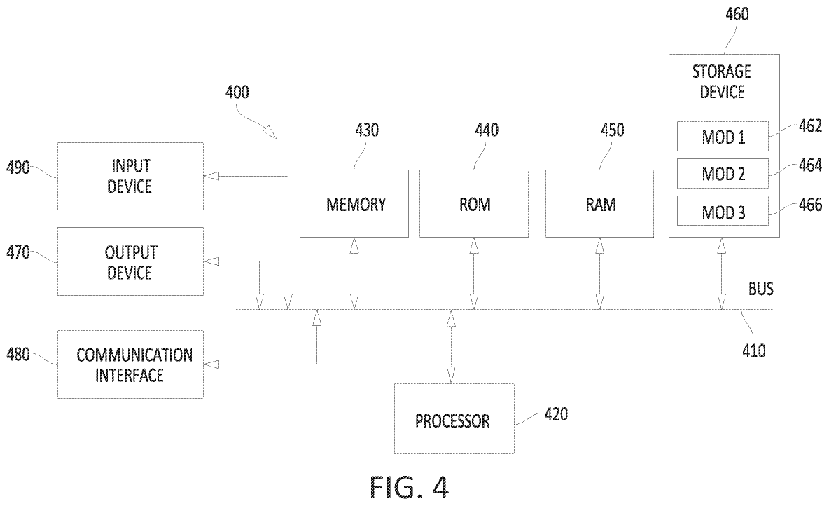

With reference to FIG. 4, an exemplary system includes a general-purpose computing device 400, including a processing unit (CPU or processor) 420 and a system bus 440 that couples various system components including the system memory 430 such as read-only memory (ROM) 440 and random access memory (RAM) 450 to the processor 420. The system 400 can include a cache of high-speed memory connected directly with, in close proximity to, or integrated as part of the processor 420. The system 400 copies data from the memory 430 and/or the storage device 460 to the cache for quick access by the processor 420. In this way, the cache provides a performance boost that avoids processor 420 delays while waiting for data. These and other modules can control or be configured to control the processor 420 to perform various actions. Other system memory 430 may be available for use as well. The memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general purpose processor and a hardware module or software module, such as module 1 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, bus 410, display 470, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 400 is a small, handheld computing device, a desktop computer, or a computer server.

Although the exemplary embodiment described herein employs the hard disk 460, other types of computer-readable media which can store data that are accessible by a computer, such as magnetic cassettes, flash memory cards, digital versatile disks, cartridges, random access memories (RAMs) 450, and read-only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
training an attendee matchmaking algorithm, by:
inputting, into a computer system, attendance data from multiple past events;
inputting, into the computer system, registration data from the multiple past events;
inputting, into the computer system, session data from the multiple past events;
executing, via a processor of the computer system, a sensitivity analysis on the attendance data, the registration data, and the session data, resulting in relevance coefficients; and
generating, via the processor, the attendee matchmaker algorithm using the relevance coefficients;
receiving, at the processor, recorded audio from a mobile computing device of an attendee of an ongoing event;
executing, via the processor, natural language processing on the recorded audio, resulting in processed audio;
executing, via the processor, the attendee matchmaking algorithm with the processed audio as an input, resulting in an output of the attendee matchmaking algorithm comprising ranked suggestions; and
transmitting the ranked suggestions from the computer system to the mobile computing device.

2. The method of claim 1, wherein the sensitivity analysis for the attendee matchmaking analysis further receives, as inputs:
topics of interest by the attendee; and
people with whom the attendee spoke at the multiple past events.

3. The method of claim 1, wherein the ranked suggestions comprise at least one of an individual with whom the attendee is recommended to communicate, a session of the event the attendee is recommended to attend, an exhibitor booth the attendee is recommended to visit, a web page the attendee is recommended to visit, and a meeting of multiple individuals which the attendee is recommended to join.

4. The method of claim 1, wherein the sensitivity analysis comprises at least one of: a derivative-based local method, a regression analysis, a variance-based method, and scatter plots.

5. The method of claim 1, further comprising:
receiving location coordinates for future activities at the ongoing event; and
receiving global positioning system (GPS) locations for the attendee,
wherein the ranked suggestions are filtered based on a distance between the location coordinates for future activities and the GPS locations for the attendee.

6. The method of claim 1, further comprising:
receiving additional actions of the attendee after receiving the ranked suggestions; and
modifying the attendee matchmaking algorithm based on the additional actions.

7. The method of claim 1, wherein each suggestion in the ranked suggestions comprises:
at least one of a person to meet and a session to attend; and
a reason for the suggestion.

8. A system comprising:
a processor; and
a non-transitory computer-readable storage medium having instructions stored which, when executed by the processor, cause the processor to perform operations comprising:
training an attendee matchmaking algorithm, by:
inputting attendance data from multiple past events;
inputting registration data from the multiple past events;
inputting session data from the multiple past events;
executing a sensitivity analysis on the attendance data, the registration data, and the session data, resulting in relevance coefficients; and
generating the attendee matchmaker algorithm using the relevance coefficients;
receiving recorded audio from a mobile computing device of an attendee of an ongoing event;
executing natural language processing on the recorded audio, resulting in processed audio;
executing the attendee matchmaking algorithm with the processed audio as an input, resulting in an output of the attendee matchmaking algorithm comprising ranked suggestions; and
transmitting the ranked suggestions from the computer system to the mobile computing device.

9. The system of claim 8, wherein the sensitivity analysis for the attendee matchmaking analysis further receives, as inputs:
topics of interest by the attendee; and
people with whom the attendee spoke at the multiple past events.

10. The system of claim 8, wherein the processor is part of a serverless computing system.

11. The system of claim 8, wherein the sensitivity analysis comprises at least one of: a derivative-based local method, a regression analysis, a variance-based method, and scatter plots.

12. The system of claim 8, the non-transitory computer-readable storage medium having additional instructions which, when executed by the processor, cause the processor to perform operations comprising:
receiving location coordinates for future activities at the ongoing event; and
receiving global positioning system (GPS) locations for the attendee,
wherein the ranked suggestions are filtered based on a distance between the location coordinates for future activities and the GPS locations for the attendee.

13. The system of claim 8, the non-transitory computer-readable storage medium having additional instructions which, when executed by the processor, cause the processor to perform operations comprising:
receiving additional actions of the attendee after receiving the ranked suggestions; and
modifying the attendee matchmaking algorithm based on the additional actions.

14. The system of claim 8, wherein each suggestion in the ranked suggestions comprises:
at least one of a person to meet and a session to attend; and
a reason for the suggestion.

15. A non-transitory computer-readable storage medium having instructions stored which, when executed by a processor, cause the processor to perform operations comprising:
training an attendee matchmaking algorithm, by:
inputting attendance data from multiple past events;
inputting registration data from the multiple past events;
inputting session data from the multiple past events;
executing a sensitivity analysis on the attendance data, the registration data, and the session data, resulting in relevance coefficients; and
generating the attendee matchmaker algorithm using the relevance coefficients;
receiving recorded audio from a mobile computing device of an attendee of an ongoing event;
executing natural language processing on the recorded audio, resulting in processed audio;
executing the attendee matchmaking algorithm with the processed audio as an input, resulting in an output of the attendee matchmaking algorithm comprising ranked suggestions; and
transmitting the ranked suggestions from the computer system to the mobile computing device.

16. The non-transitory computer-readable storage medium of claim 15, wherein the sensitivity analysis for the attendee matchmaking analysis further receives, as inputs:
topics of interest by the attendee; and
people with whom the attendee spoke at the multiple past events.

17. The non-transitory computer-readable storage medium of claim 15, wherein the processor is part of a serverless computing system.

18. The non-transitory computer-readable storage medium of claim 15, wherein the sensitivity analysis comprises at least one of: a derivative-based local method, a regression analysis, a variance-based method, and scatter plots.

19. The non-transitory computer-readable storage medium of claim 15, having additional instructions which, when executed by the processor, cause the processor to perform operations comprising:
receiving location coordinates for future activities at the ongoing event; and
receiving global positioning system (GPS) locations for the attendee,
wherein the ranked suggestions are filtered based on a distance between the location coordinates for future activities and the GPS locations for the attendee.

20. The non-transitory computer-readable storage medium of claim 15, having additional instructions which, when executed by the processor, cause the processor to perform operations comprising:
receiving additional actions of the attendee after receiving the ranked suggestions; and
modifying the attendee matchmaking algorithm based on the additional actions.
